(19) United States
(12) Patent Application Publication
(10) Pub. No.: US 2015/0138744 A1
(43) Pub. Date: May 21, 2015

(54) PRINTED CIRCUIT BOARD

(71) Applicants: HONG FU JIN PRECISION INDUSTRY (SHENZHEN) CO., LTD., SHENZHEN (CN); HON HAI PRECISION INDUSTRY CO., LTD., NEW TAIPEI (TW)

(72) Inventors: SHI-PIAO LUO, Shenzhen (CN); SHENG-CUN ZHENG, Shenzhen (CN); CHIA-NAN PAI, Tu-Cheng (TW); SHOU-KUO HSU, Tu-Cheng (TW)

(73) Assignees: HONG FU JIN PRECISION INDUSTRY (SHENZHEN) CO., LTD., SHENZHEN (CN); HON HAI PRECISION INDUSTRY CO., LTD., NEW TAIPEI (TW)

(21) Appl. No.: 14/250,399

(22) Filed: Apr. 11, 2014

(30) Foreign Application Priority Data
Nov. 18, 2013 (CN) 2013105757259

(51) Int. Cl. H02H 3/08

(52) U.S. Cl. CPC H02H 3/08
USPC 361/782

(57) ABSTRACT

A printed circuit board includes a baseboard, first and second conductive wires, a fuse, a 5V connector, a USB connector, and a CPU. The 5V connector is electrically connected to a first end of the fuse through the first conductive wire, and electrically connected to a voltage pin of the CPU voltage regulating chip through the second conductive wire. A voltage pin of the USB connector is connected to a second end of the fuse. The 5V connector outputs a 5V system voltage to the USB connector through the first conductive wire and the fuse, thus providing a voltage to a USB device, and also outputs the 5V system voltage to the CPU voltage regulating chip through the second conductive wire, thus signaling the CPU voltage regulating chip to convert the 5V system voltage and provide the converted voltage to a CPU.

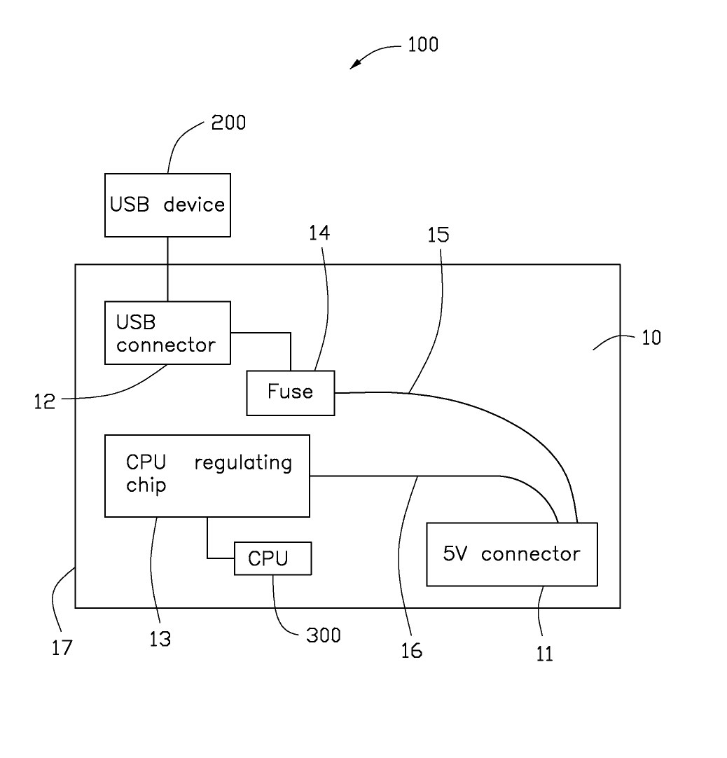

### FIELD

The present disclosure relates to a printed circuit board.

### BACKGROUND

A system voltage terminal P5V of a motherboard outputs a 5 volt (V) voltage to loads, such as a universal serial bus (USB) connector and a central processing unit (CPU) voltage regulating chip, through a same wire of the motherboard. The 5V voltage output from the system voltage terminal P5V is provided to the USB connector through a fuse to prevent the USB connector from receiving over-current. However, when the USB connector operates abnormally, such as when the USB connector receives over-current or short circuited, the system voltage terminal P5V stops outputting the 5V voltage, which causes the CPU voltage regulating chip to stop operating, and thus power off the motherboard. Therefore, there is room for improvement in the art.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The FIGURE is a block diagram of an embodiment of a printed circuit board.

### DETAILED DESCRIPTION

The disclosure, including the drawing, is illustrated by way of example and not by way of limitation. References to “an” or “one” embodiment in this disclosure are not necessarily to the same embodiment, and such references mean “at least one.”

The FIGURE shows an embodiment of a printed circuit board (PCB) 100. The PCB 100 includes a baseboard 10. A 5 volt (V) connector 11, a universal serial bus (USB) connector 12, a central processing unit (CPU) voltage regulating chip 13, a fuse 14, a first conductive wire 15, and a second conductive wire 16 are all arranged on the baseboard 10. Of course, the PCB 100 can include other elements that are known in the art. The positions of the 5V connector 11, the USB connector 12, the CPU voltage regulating chip 13, and the fuse 14 can be changed according to need.

The 5V connector 11 is electrically connected to a first end of the fuse 14 through the first conductive wire 15. A second end of the fuse 14 is electrically connected to a voltage pin of the USB connector 12. The 5V connector 11 is also connected to a voltage pin of the CPU voltage regulating chip 13 through the second conductive wire 16.

When the PCB 100 is in use, a 5V system voltage output from the 5V connector 11 is provided to the voltage pin of the USB connector 12 through the first conductive wire 15 and the fuse 14, thus providing voltage to a USB device 200 connected to the USB connector 12. Simultaneously, the 5V system voltage output from the 5V connector 11 is also provided to the voltage pin of the CPU voltage regulating chip 13 through the second conductive wire 16, thus signaling the CPU voltage regulating chip 13 to convert the 5V system voltage. The CPU voltage regulating chip 13 provides the converted voltage to a CPU 300. In one embodiment, the first and second conductive wires 15 and 16 are electrically separated and physically connected to the 5V connector 11. Thus, voltages are provided to the USB connector 12 and the CPU voltage regulating chip 13 through two separate pathways, thereby avoiding signal interference between the USB connector 12 and the CPU voltage regulating chip 13. In the embodiment, the first and second conductive wires 15 and 16 are traces laid on the PCB 100. The first and second conductive wires 15 and 16 can be arranged in different layers of the PCB 100.

Table 1 shows simulation data of a general PCB and the PCB 100 when the USB connector 12 operates normally, and table 2 shows simulation data of a general PCB and the PCB 100 when the USB connector 12 receives over-current or short circuited.

TABLE 1

| | | | Voltage | |
|---|---|---|---|---|
| | Operation | Voltage drop | drop of the | Voltage drop of |
| Load | current | standard | general PCB | the PCB 100 |
| CPU voltage | 0.1 A | <250 mV | 145 mV | 128 mV |
| regulating chip | | | | |
| USB connector | 1 A | <250 mV | 165 mV | 168 mV |

As shown in table 1, when the USB connector 12 operates normally, the voltage drop of the CPU voltage regulating chip 13 of the general PCB is 145 millivolts (mV), and the voltage drop of the CPU voltage regulating chip 13 of the PCB 100 is 128 mV. The voltage drop of the USB connector 12 of the general PCB is 165 mV, and the voltage drop of the USB connector 12 of the PCB 100 is 168 mV (substantially the same as the general PCB). Thus, when the USB connector 12 operates normally, the voltage drop of the USB connector 12 of the general PCB and the PCB 100 are substantially the same, and the voltage drop of the CPU voltage regulating chip 13 of the PCB 100 is lower.

TABLE 2

| | | | Voltage | |
|---|---|---|---|---|
| | Operation | Voltage drop | drop of the | Voltage drop of |
| Load | current | standard | general PCB | the PCB 100 |
| CPU voltage | 0.1 A | <250 mV | 255 mV | 165 mV |
| regulating chip | | | | |
| USB connector | 4 A | <250 mV | 651 mV | 669 mV |

As shown in table 2, when the USB connector 12 receives over-current or is short circuited, the voltage drop of the CPU voltage regulating chip 13 of the general PCB is 255 mV, which is greater than 250 mV of the voltage drop standard. Thus, the CPU voltage regulating chip 13 does not operate normally, resulting in the CPU 300 powering off. In contrast, the voltage drop of the CPU voltage regulating chip 13 of the PCB 100 is 165 mV, which is less than 250 mV of the voltage drop standard. Thus, when the USB connector 12 receives over-current or short circuited, the CPU voltage regulating chip 13 of the PCB 100 continues to operate normally, thus preventing the CPU 300 from powering off.

The first and second conductive wires 15 and 16 are electrically and physically connected to the 5V connector 11, thus providing voltages to the USB connector 12 and the CPU voltage regulating chip 13 through two separate pathways. As a result, the voltage drop of the CPU voltage regulating chip 13 is reduced when the USB connector 12 operates normally, and the CPU voltage regulating chip 13 operates normally when the USB connector 12 receives over-current or short circuited.

Even though numerous characteristics and advantages of the disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A printed circuit board comprising:
a baseboard;
a first conductive wire arranged on the baseboard;
a second conductive wire arranged on the baseboard;
a fuse arranged on the baseboard;
a 5 volt (V) connector arranged on the baseboard, wherein the 5V connector is connected to a first end of the fuse through the first conductive wire;
a universal serial bus (USB) connector arranged on the baseboard, wherein a voltage pin of the USB connector is connected to a second end of the fuse; and
a central processing unit (CPU) voltage regulating chip, wherein a voltage pin of the CPU voltage regulating chip is connected to the 5V connector through the second conductive wire;
wherein the 5V connector outputs a 5V system voltage to the voltage pin of the USB connector through the first conductive wire and the fuse, to provide a voltage to a USB device connected to the USB connector, and the 5V connector also outputs the 5V system voltage to the voltage pin of the CPU voltage regulating chip through the second conductive wire, to signal the CPU voltage regulating chip to convert the 5V system voltage and provide the converted voltage to a CPU.

2. The printed circuit board of claim 1, wherein the first and second conductive wires are traces, which are laid on the printed circuit board.
